(19) United States
(12) Patent Application Publication
(10) Pub. No.: US 2014/0250055 A1
(43) Pub. Date: Sep. 4, 2014

(54) Systems and Methods for Associating Metadata With Media Using Metadata Placeholders

(71) Applicants: David Kuspa, San Jose, CA (US); Mark Mapes, Carmichael, CA (US); Benoit Ambry, Fair Oaks, CA (US)

(72) Inventors: David Kuspa, San Jose, CA (US); Mark Mapes, Carmichael, CA (US); Benoit Ambry, Fair Oaks, CA (US)

(73) Assignee: ADOBE SYSTEMS INCORPORATED

(21) Appl. No.: 12/168,522

(22) Filed: Jul. 7, 2008

Related U.S. Application Data
(60) Provisional application No. 61/123,824, filed on Apr. 11, 2008.

(51) Int. Cl. G06F 7/00; G06F 17/30

(52) U.S. Cl. 707/603; 707/E17.014; 707/E17.028; 707/758

(57) ABSTRACT

Certain embodiments described herein provide methods and systems that use metadata placeholders to facilitate the association of metadata with recorded media content. Metadata placeholders, for example, may be created prior to recording content and then used at the time of the recording and editing of the actual content. Metadata placeholders can be used to make useful information, including a director's shot plan and other shot attribute information, available on-location to be used and edited by those present at recording and to facilitate the association of the information with the actual recorded content. One exemplary method involves creating a metadata placeholder for a shot, including information about the shot in the metadata fields of the metadata placeholder, and then storing the placeholder's metadata with the content that is recorded for the shot.

### CROSS-REFERENCE TO RELATED APPLICATIONS

This application claims priority to U.S. Provisional Application Ser. No. 61/123,824 filed Apr. 11, 2008, entitled “Systems and Methods for Associating Metadata with Video Media Using Metadata Placeholders and for Capturing and Using Metadata from Spoken Media Content,” the entirety of which is incorporated herein by reference.

### FIELD OF THE INVENTION

Embodiments of the present disclosure relate generally to storing or using recorded media and associated metadata, including information created prior to and used during recording of the media.

### BACKGROUND

Video and other rich media are often opaque in the sense that the media's content, source, and other properties are difficult to identify from the media itself. Such information is usually only available if someone has taken the time to examine the media's content and manually associate metadata describing the content with the media. Moreover, information associated after the media's creation may be inaccurate and is likely to lack information not available from an after-the-fact inspection of the media, such as information known only at the time of the media's development. For example, information used by movie directors to plan and conduct the shots of a movie may not be available later to third party observers. Typically, prior to recording one or more shots for a given movie scene, directors decide on a variety of shot attributes and often create a shot plan that includes information describing the shot's content, camera angles, actors, location details, references to the corresponding pages of the written script, among many other things. The shot plan and its attributes are then used as a reference or guide while recording the shots on film. In some cases, after content is recorded to film, the recorded content is then captured from the film and stored elsewhere for selection, editing, and other purposes. For example, the recorded content may have been converted to a digital format and stored on a computer hard drive. This typical film production process does not facilitate the creation and association of metadata with recorded content and often results in the loss of, among other things, the information about the shot attributes used by the director.

### SUMMARY

Certain embodiments described herein provide methods and systems for associating metadata with media using metadata placeholders. One exemplary embodiment provides a method comprising receiving shot metadata for inclusion in a metadata placeholder for a planned shot. The method further comprises receiving a record command including an identification of the metadata placeholder for the planned shot. In response to the record command, the method controls a recording device to record the recorded content for the planned shot, receives the recorded content from the recording device, and associates the metadata from the metadata placeholder with the recorded content, for example by embedding the metadata in a file with the recorded content or by including an identification of the recorded content with the metadata.

Another exemplary method comprises receiving a multi-shot plan comprising information about each of a plurality of shots, creating metadata placeholders for the shots including information from the multi-shot plan about a shot, receiving a selection of a selected metadata placeholder from amongst the metadata placeholders for each of the shots. The method further comprises receiving recorded content from a recording device for the shot corresponding to the selected metadata placeholder, and associating the information about the shot from the selected metadata placeholder with the recorded content.

In other embodiments, a computer-readable medium (such as, random access memory or a computer disk) comprises code for carrying out these methods.

These embodiments are mentioned not to limit or define the disclosure, but to provide examples of embodiments to aid understanding thereof Embodiments are discussed in the Detailed Description, and further description is provided there. Advantages offered by the various embodiments may be further understood by examining this specification.

### BRIEF DESCRIPTION OF THE FIGURES

These and other features, aspects, and advantages of the present disclosure are better understood when the following Detailed Description is read with reference to the accompanying drawings, wherein:

FIG. 1 is a flow chart illustrating a method of creating and editing metadata placeholders during media development according to certain embodiments;

FIG. 2 is an illustration of an illustrative user interface (UI) for creating, maintaining, and editing metadata placeholders and recording footage according to certain embodiments;

FIG. 3 is an illustration of selecting a recoding mode in the UI of FIG. 2 according to certain embodiments;

FIG. 4 is an illustration of an empty metadata placeholder in the UI of FIG. 2 according to certain embodiments;

FIG. 5 is an illustration of a selected group of metadata placeholders in the UI of FIG. 2 according to certain embodiments;

FIG. 6 is an illustration of a metadata display window in the UI of FIG. 2 according to certain embodiments; and

FIG. 7 is a system diagram illustrating an illustrative environment for using a metadata placeholder according to certain embodiments.

### DETAILED DESCRIPTION

Certain embodiments described herein provide methods and systems that use metadata placeholders to facilitate the association of metadata with recorded media content. Metadata placeholders, for example, may be created prior to recording content and then used at the time of the recording and editing of the actual content. Metadata placeholders can be used to make useful information, including a director's shot plan and other shot attribute information, available to be used and edited by those present at recording and to facilitate the association of the information with the actual recorded content. One exemplary method involves creating a metadata placeholder for a shot, including information about the shot in the metadata fields of the metadata placeholder, and then storing the placeholder's metadata with the content that is recorded for the shot.

In one exemplary embodiment, in anticipation of recording multiple shots for a given scene, a director may use a computer application to create a metadata placeholder for each shot of the scene. The director may also enter shot attribute and other information about a shot into the metadata fields of the shot's metadata placeholder. At the recording location (“on location”), the director may use a computing application to view, edit, and/or otherwise use the metadata placeholders.

Recording equipment used to capture content for a given shot may be used in conjunction with the metadata placeholder application. For example, at the time of recording a given shot, the metadata application may provide the metadata from the shot's metadata placeholder to be stored with or otherwise associated with the shot. For example, the metadata placeholder application may provide metadata for the shot to be stored with the recorded content, e.g., the metadata from a placeholder may be embedded in a file that is used to hold some or all of the recorded content. In other embodiments, the metadata from a metadata placeholder is stored separately from the recorded content but associated with the piece of stored content in some manner. For example, a piece of recorded content may be given a unique identifier that is included with the metadata from the placeholder to associate the metadata with the piece of recorded content.

Other embodiments of the present disclosure provide additional methods of creating metadata during media development using metadata placeholders. One exemplary method comprises creating a shot plan for a piece of media prior to recording the shots for the media and using information from the shot plan to populate metadata fields of metadata placeholders. A director or other user may use the metadata placeholders during recording of the shots. For example, if the metadata placeholders are stored electronically, the user may access an application that displays a list of metadata placeholders. For a given shot, the user may select the corresponding metadata placeholder and access the shot plan information stored in that metadata placeholder's metadata fields. The user may make edits or changes to the information based on the actual recording conditions and any other on-location changes. In some cases, the application may also allow the user to control a recording device. For example, the user may select a metadata placeholder from a list of placeholders in the application and initiate a command to record a shot and automatically merge the metadata of that placeholder with the recorded content.

Associating metadata from metadata placeholders with recorded content provides a variety of advantages and benefits. For example, the metadata may facilitate editing of a recorded shot and/or may be used to navigate to or search for a particular shot or take during editing or other use of the content recordings. Additional advantages result from the enhanced metadata associated with the media generally, including benefits arising from the inclusion of information that might otherwise be lost if not recorded early in the development process. Other useful functions, advantages, and benefits are provided by the metadata placeholder and other features described in this disclosure.

### Illustrative Creation and Use of Metadata Placeholders

The following specific illustrative embodiment is provided to illustrate some of the applications, and uses of creating and using metadata placeholders.

According to an embodiment, a movie is developed in a multistage development process. At an early stage of development, a script is generated that includes written comments about various movie scenes (e.g., “the living room is a mess with banner making supplies across the floor. CLAIRE BENNETT enters from the kitchen carrying her school books and a cell phone. She looks exhausted,”); the actors' dialog (e.g., “CLAIRE I can't believe you forgot to get me . . . MR. BENNETT Do you think you could forgive me if that shiny new BMW you want showed up in the driveway on your birthday?”); and the camera angles (e.g., close-up on Claire Bennett and pan-out to Mr. Bennett).

Based on the script, the director plans a series of shots. The director then uses a computing application, on a laptop or other on location computer to create metadata placeholders for the series of shots and enters metadata for each shot. For example, the director may enter metadata relating to camera angles (e.g., pan-in/out, fade-away), a detailed scene description, location, actors, etc. for a given shot.

Then, on the day of recording, once on location, the director can connect his/her laptop to the camera(s), set an application (which may be the same application used to create the placeholders) to “Take Record Mode,” select the metadata placeholder for the desired shot, hit the record button, call “action” and record the actual shot footage. The application creates a single media file containing both the recording and associated metadata from the metadata placeholder.

The application may display a shot list that comprises a listing for each of the planned and recorded shots. The listing may display the metadata placeholders and be used to facilitate navigation and use of the metadata placeholders with the recordings. The list may also be a listing for each take of a shot. If the director decides to record a second take, the director can simply highlight the first take in the shot list, hit the record button again and call “action.” The application will automatically create another metadata placeholder inheriting the appropriate metadata details from the previous take and display it as a listing in the shot list. The application may also increment metadata identifying the “take” number as appropriate. This enables a director to shoot several takes of a shot without having to manually create metadata during or after each take of a shot.

The director can continue shooting the various planned shots by selecting the desired metadata placeholder for the shot in the shot list, hitting the record button and calling “action,” as described above. At the end of shooting, the director will have a list of media files, each including the footage and its associated metadata. For example, the list of media files as displayed may include metadata associated with each shot, including the shot number, take number, scene number, brief description, media duration, media start/end time, etc.

This illustrative example is given to introduce the reader to the general subject matter discussed herein and is not intended to limit the scope of the disclosed concepts. The following sections describe various additional embodiments and examples of methods and systems for creating and using metadata placeholders and associated media.

### Illustrative Method for Creation of Metadata Placeholders During Development

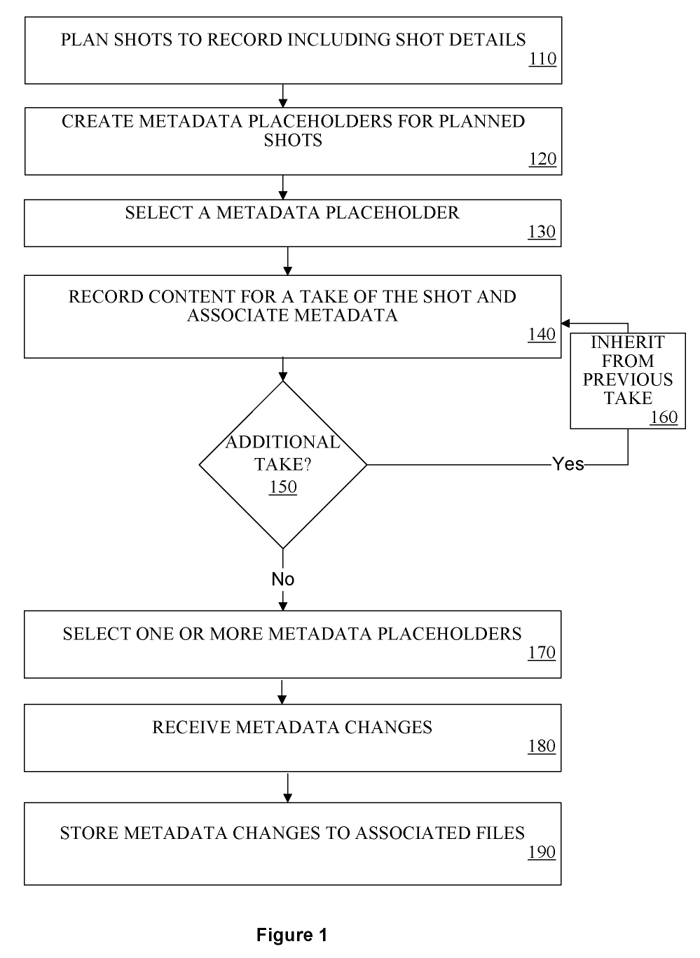

Referring now to the drawings in which like numerals indicate like elements throughout the several Figures. FIG. 1 is a flow chart illustrating a method of creating and editing metadata placeholders during media development according to certain embodiments.

The development of a piece of media can vary significantly depending on the type and content of the media being developed. In many cases, media development involves multiple steps performed by multiple persons and involves the use of multiple content capturing, importing, editing, and distributing tools. However, development of certain media can also be relatively simple and involve a single director using a single tool to develop a piece of media.

In the method shown in FIG. 1, a producer, director, other user plans shots to be recorded, including the related details for each shot, as shown in block 110. For example, based on a script, a user or application may plan a series of shots that are to be recorded during the first day of recording. Alternatively, a shot plan can be automatically generated by an application with or without user involvement. A shot plan, among other things, generally provides a shot-by-shot outline for developing the scenes of the piece of media. A shot plan may or may not be written or recorded. For instance, a user may use a storyboard, which is a series of conceptual drawings that depict how the script unfolds shot by shot, or the user may simply mentally develop the shot plan without jotting down the details. A shot plan may provide information for less than all of the shots and/or less than all of the scenes.

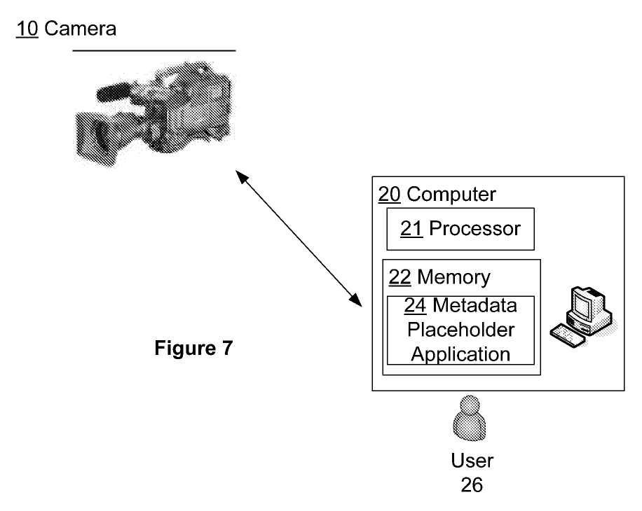

After developing a shot plan, a user may use a computing application to create metadata placeholders for the planned shots, as shown in block 120. For example, the user 26 may use a computer such as computer 20 having a metadata placeholder application 24 as shown in FIG. 7, to create metadata placeholders for the planned shots.

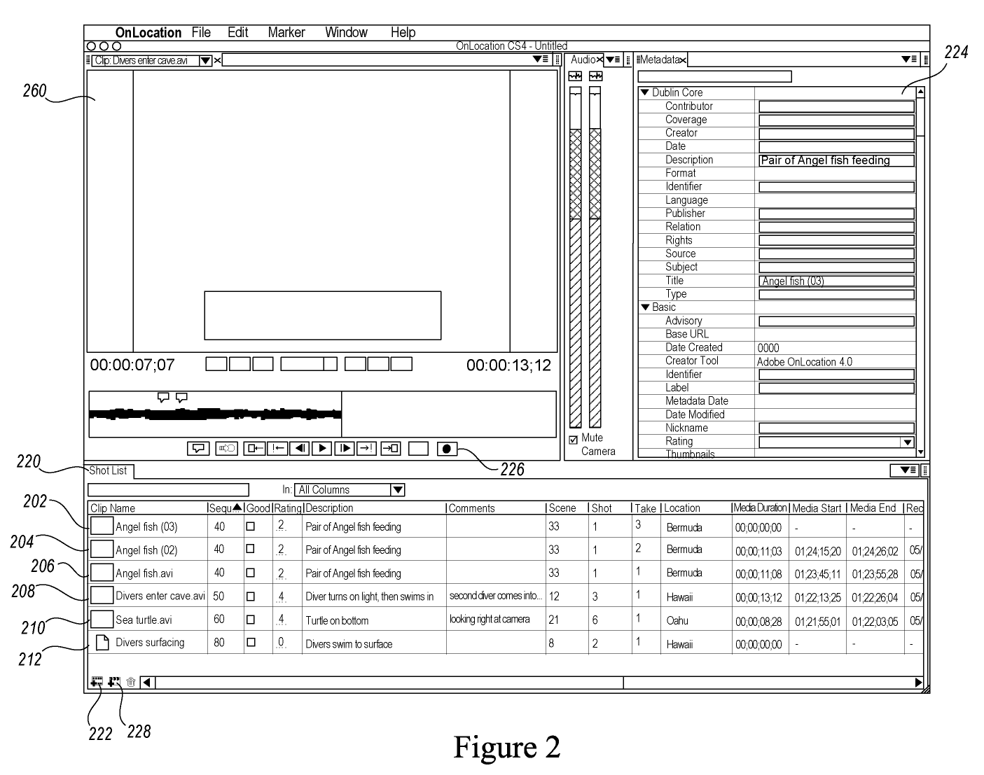

FIG. 2 is an illustrative application user interface (UI) environment according to certain embodiments. The recording application UI shown in FIG. 2 illustrates an example UI of a metadata placeholder application 24 used to create metadata placeholders. When the “add shot placeholder” button 222 in the lower left corner is selected, the metadata placeholder application 24 creates a new metadata placeholder for a shot. When the “add take placeholder” button 228 is selected, the metadata placeholder application 24 creates a new metadata placeholder for a new take of a shot. The metadata placeholder application 24 creates a metadata placeholder, and allows the user 26 to add metadata to the placeholder.

For example, to set-up a metadata placeholder for scene A, shot A2, a user 26 can enter the related metadata, such as a description of the shot, the scene and shot number, camera angles, etc., either by typing directly into the appropriate metadata field as displayed in the shot list 220 or by entering metadata for the placeholder in the metadata list 224. The metadata list 224 lists all of the available metadata fields for the placeholder(s) currently selected on the shot list 220. The shot list 220 may display an abbreviated (and possibly customized) list of metadata fields. In FIG. 2, the metadata placeholders 202, 204, 206, 208, 210, and 212 are listed in the shot list 220 in a spreadsheet type of layout. Other layouts are of course possible. The UI shown in FIG. 2 may be used within the hardware configuration illustrated in FIG. 7 to allow a user 26 to produce and edit a set of metadata placeholders, as shown in block 120 of FIG. 1.

In other embodiments, the metadata placeholder application 24 may accept a written script as input, parse and convert the script into shot plan metadata and create a series of metadata placeholders containing the relevant metadata as detailed in the script for each shot. Thus, the metadata placeholder application 24 may automatically plan the shots from a script and/or other information, and may automatically create metadata placeholders for each planned shot, as shown in blocks 110 and 120, respectively.

Once on location for recording, with a recording device 10 (e.g., a production camera as illustrated in FIG. 7) connected to a user's computing device, such as a laptop 20, the user 26 may select a metadata placeholder, as shown in block 130. The metadata placeholder application 24 may list the metadata placeholders in a shot list 220.

A metadata placeholder application 24 may be used to record a take of the associated shot. As shown in block 140, when a record button 226 is selected, a metadata placeholder application 24 may control or otherwise initiate the recording of a take of the shot associated with a metadata placeholder. Live video/audio footage may be displayed in the playback display 260. The metadata placeholder application 24 may associate the metadata from the selected metadata placeholder with the recorded content (such as by using a unique identifier), as shown in block 140. In the alternative, the metadata placeholder application 24 may record the recorded content into a file along with the associated metadata from the selected metadata placeholder, as shown in block 140. In some embodiments, the metadata placeholder application 24 may compress the recorded content to facilitate storage and use of the recorded content and associated metadata on other computing devices. This may be useful, for example, where the content is high-definition video stored as digital content on a computing device.

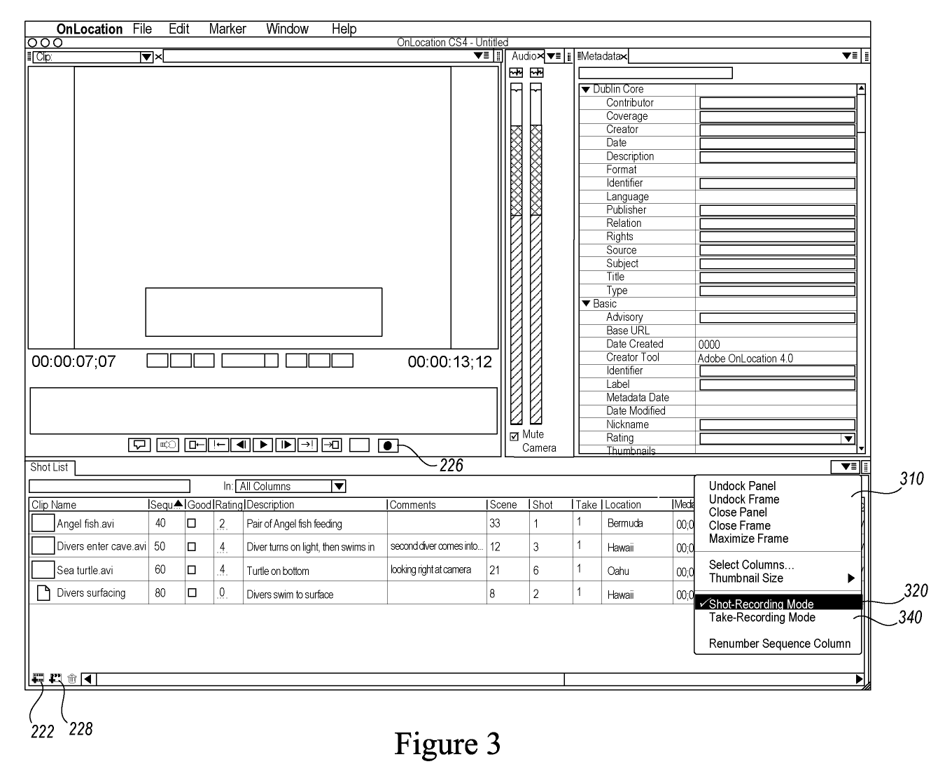

The recording application may include a “Shot Record Mode” and a “Take Record Mode.” As shown in FIG. 3, via the drop-down menu 310 the record mode may be selected or changed. If the “Take Record Mode” 340 is selected, when a user selects an empty metadata placeholder (i.e., a metadata placeholder with no media recorded) and selects the record button 226, the application records the live video/audio stream and the metadata is included with the media file. The metadata in the metadata placeholder may be stored as embedded metadata, in XML format or as an extensible metadata platform (XMP) portion of a media file. Any changes made to the metadata after the shot is recorded may be saved and applied to the stored media file.

In some embodiments, if an additional take is desired, as shown in block 150, in the “Take Record Mode” after a current metadata placeholder is associated with footage (i.e., a single media file containing both the media and the metadata), if a user selects that file by clicking on an associated placeholder in the shot list 220, and then selects the record button 226 again, the application automatically creates a new metadata placeholder for the new recording, wherein the metadata placeholder inherits the metadata from the selected placeholder, as shown in block 160. The application may also increment the take number accordingly and store the take number as part of the metadata. For example, if a director records shot B take B1 and decides to record another take, by selecting the shot B take B1 file in the shot list 220 and then selecting the record button 226, the application (in “Take Record Mode”) creates a new metadata placeholder inheriting the associated metadata from the previous shot and increments the take number accordingly—shot B take B2. This enables a user to quickly and effortlessly create multiple takes for a shot without having to manually recreate metadata for each take.

In some embodiments, while in “Take Record Mode” after a current metadata placeholder is associated with footage (e.g., shot 22 take 2), if no file (i.e., metadata placeholder) is selected in the shot list 220 when a user selects the record button 226 again, the application automatically creates a new metadata placeholder for the new shot recording. Since no predecessor was selected, the new metadata placeholder does not inherit metadata from the most recent placeholder (i.e., no metadata is copied/cloned from the most recent placeholder).

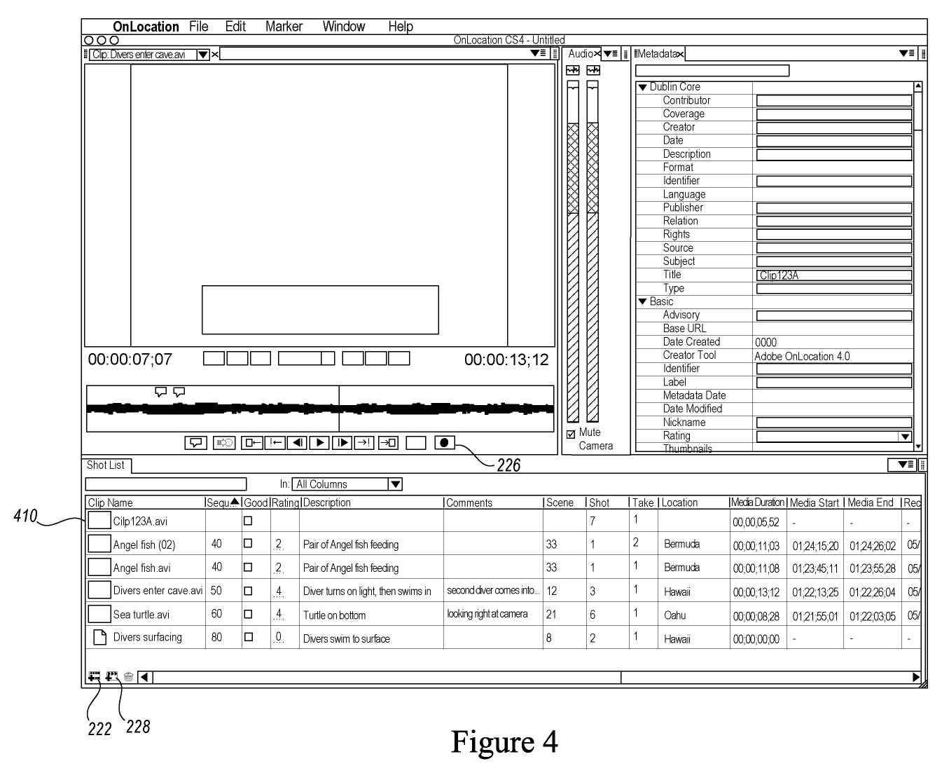

As shown in FIG. 3, if the “Shot Record Mode” 320 is selected, when a user selects the record button 226 the application may record a new shot with no metadata. For example, as shown in FIG. 4, when the application is in “Shot Record Mode” and a user selects record 226, a new shot 410 is created with no metadata. In certain embodiments, in “Shot Record Mode” when a user selects a metadata placeholder not yet associated with a recording and selects the record button, the application records the live video/audio stream and the metadata of that placeholder is included with the media file (i.e., the same behavior as in “Take Record Mode”).

The method of FIG. 1 may further allow for editing of the metadata associated with a piece of recorded content. The method may comprise selection of one or more metadata placeholders, as shown in block 170, and receiving a change to the metadata of that placeholder, as shown in block 180. The changed metadata can then be stored, for example, the metadata changes may be stored as part of the associated file, as shown in FIG. 190.

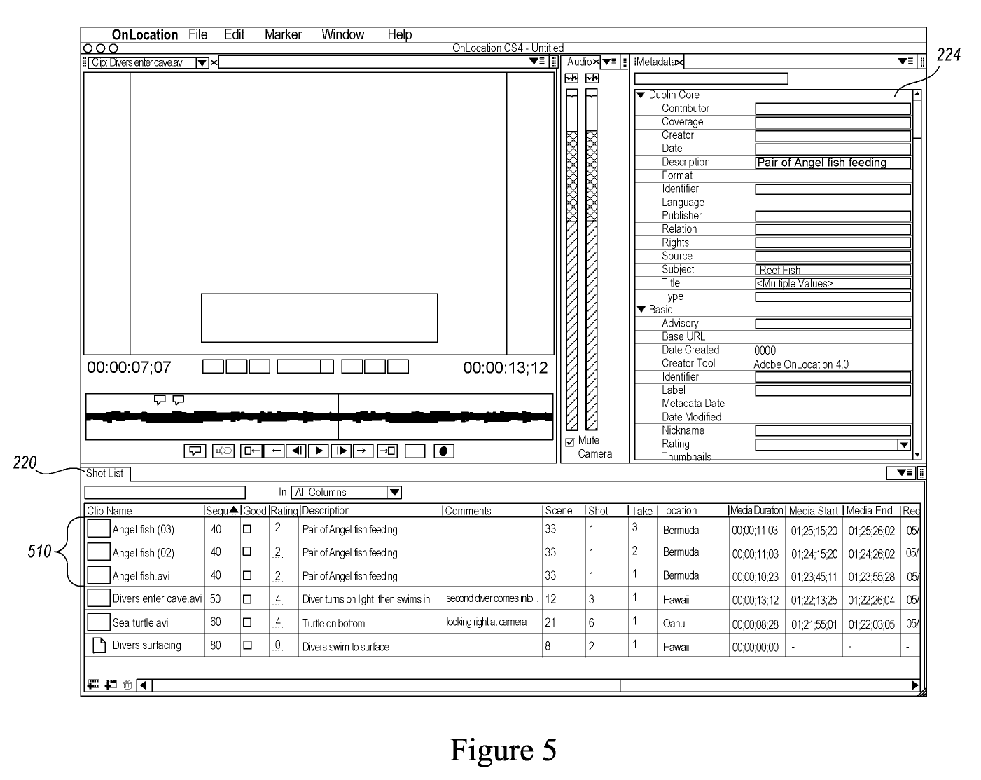

Certain embodiments facilitate editing of metadata associated with multiple placeholder and/or pieces of recorded content. As illustrated in FIG. 5, the metadata for multiple placeholders in a shot list 220 can be modified by selecting multiple placeholders 510 in the shot list 220 and then editing a metadata field in the metadata list 224. When multiple placeholders and/or pieces of recorded content are selected, an application editing interface may allow editing of fields that are common to all of the items. For example, all of a group of selected metadata placeholders may have a common “location” metadata field.

By saving changes made to a common metadata field, the associated metadata for the entire group of selected files 510 may be saved, for example, in an XMP portion of each selected media file accordingly. As described, the metadata list 224 allows a user to easily update metadata for individual or multiple media files. In some embodiments, a user may select multiple files 510 in a shot list 220, edit a metadata field in the shot list 220 for only one of the files, and have the change applied to all of the multiple files 510 in the selection and saved accordingly.

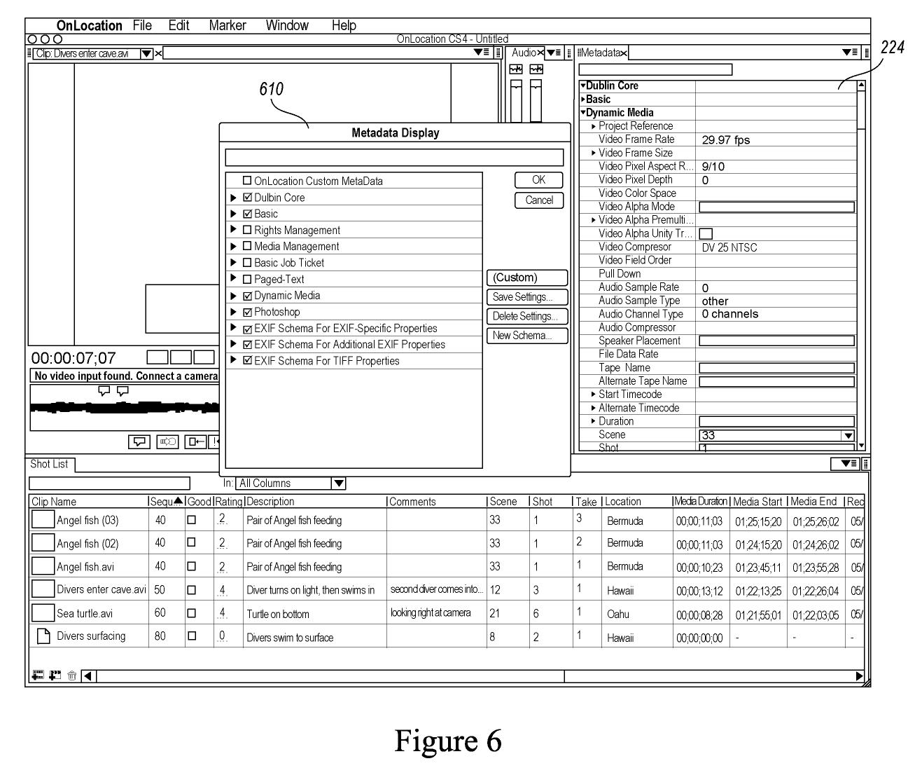

As shown in FIG. 6, the metadata window 610 displays all of the available metadata schemas, which are groups of associated metadata properties. Using the metadata window 610, a user can select and/or deselect a metadata schema for display in the metadata list 224. For example, for all “Dynamic Media” metadata schema some of the metadata properties include: shot, scene, take number, location, comments, etc. The metadata window 610 is a metadata schemas list that may be shared in multiple applications. If the metadata is written into the media files themselves according to a given metadata schema, the metadata may be accessible in all applications that support that schema.

### Illustrative Environment Configuration

FIG. 7 is a system diagram illustrating an illustrative environment for using a metadata placeholder according to certain embodiments. Other embodiments may be utilized. The environment shown in FIG. 7 comprises a wired or wireless connection between a camera 10 and a computer 20. As is known to one of skill in the art, applications, such as the metadata placeholder application 24 may be resident in any suitable computer-readable medium and execute on any suitable processor. For example, the computer 20 may comprise a computer-readable medium such as a random access memory coupled to a processor 21 that executes computer-executable program instructions stored in memory 22. Such processor 21 may comprise a microprocessor, an ASIC, a state machine, or other processor, and can be any of a number of computer processors. Such processor comprises, or may be in communication with a computer-readable medium which stores instructions that, when executed by the processor, cause the processor to perform the steps described herein.

A computer-readable medium may comprise, but is not limited to, an electronic, optical, magnetic, or other storage or transmission device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. A computer-readable medium may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

The device 20 may also comprise a number of external or internal devices such as a mouse, a CD-ROM, DVD, a keyboard, a display, or other input or output devices. Examples of devices that could execute a metadata placeholder application 24 are personal computers, digital assistants, personal digital assistants, cellular phones, mobile phones, smart phones, pagers, digital tablets, laptop computers, Internet appliances, other processor-based devices, and television viewing devices. In general, a device may be any type of processor-based platform that operates on any operating system capable of supporting one or more client applications or programs.

For FIG. 7, a user computer 20 with a processor 21 and a metadata placeholder application 24 in its memory 22 may be used by a user 26 to perform some or all of the development of a piece of media. For example, the metadata placeholder application 24 may include a script writing application for a user 26 to enter a movie script, or an editing application to edit files comprised of the metadata and recorded content. In some embodiments, the metadata placeholder application 24 may be comprised of a single application for creating and editing metadata placeholders. In other embodiments, the metadata placeholder application 24 may be comprised of multiple applications for the creation of and editing of metadata placeholders.

According to one embodiment, a user 26 may use a system comprised of a recording device, such as camera 10 and a control device, such as computer 20. The control device 20 may include a metadata placeholder application 24 capable of receiving shot metadata for inclusion in metadata placeholders and controlling the recording device 10 to record content. The metadata placeholder application 24 may be capable of receiving recorded contents from the recording device 10, embedding metadata from the metadata placeholders in files comprising the recorded contents, and storing the files in the memory 22 of the control device 22, among other things. Other embodiments may utilize alternative hardware components and configurations. For example, certain embodiments may employ a network and store recorded content and/or metadata content at remote locations.

### General

Certain embodiments relate to creating and using metadata placeholders. These embodiments are merely illustrative. The techniques for creating metadata placeholders and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

1. A method comprising:
receiving shot metadata for inclusion in a metadata placeholder for a planned shot, the metadata placeholder created prior to recording the shot, the shot metadata comprising information inputted and included in the metadata placeholder prior to recording the shot;
receiving, at a computer, a record command, the record command comprising an identification of the metadata placeholder for the planned shot; and
in response to the record command:
controlling, via the computer, a camera of a recording device to record actual footage on location as recorded content for the planned shot;
receiving, at the computer, the recorded content from the recording device; and
associating, via the computer, the shot metadata from the metadata placeholder with the recorded content.

2. The method of claim 1, wherein associating the metadata from the metadata placeholder with the recorded content comprises embedding the metadata from the metadata placeholder in a file comprising the recorded content.

3. The method of claim 2, wherein embedding metadata from the metadata placeholder further comprises embedding the metadata in the file in an XML format.

4. The method of claim 1, wherein associating the metadata from the metadata placeholder with the recorded content comprises using a unique identifier for the recorded content to associate the metadata from the metadata placeholder with the recorded content.

5. The method of claim 1, wherein receiving the record command further comprises receiving a selection of a selected metadata placeholder from amongst multiple metadata placeholders provided for display on a user interface, the identification of the metadata placeholder identifying the selected metadata placeholder.

6. The method of claim 1, further comprising receiving a search request comprising a search term, and searching for a file having the search term as metadata.

7. The method of claim 1, wherein the shot metadata comprises metadata related to a camera angle, a scene description, or an actor dialog.

8. The method of claim 1, wherein the source of the shot metadata is a written script.

9. The method of claim 1, further comprising providing the metadata placeholder for display on a user interface and receiving a change to the metadata of the metadata placeholder.

10. The method of claim 9, wherein the change is an addition of metadata.

11. A method comprising:
receiving shot metadata for inclusion in a first metadata placeholder for a first planned shot;
receiving a first record command, the first record command comprising an identification of the first metadata placeholder for the first planned shot;
in response to the first record command: controlling a recording device to record the first recorded content for the first planned shot; receiving the first recorded content from the recording device; and embedding the metadata from the first metadata placeholder in a first file comprising the first recorded content;
creating a second metadata placeholder comprising at least a portion of the metadata from the first metadata placeholder;
receiving a second record command, the second record command comprising an identification of the second metadata placeholder for a second planned shot; and
in response to the second record command: controlling the recording device to record a second recorded content for the second planned shot; receiving the second recorded content from the recording device; and embedding the metadata from the second metadata placeholder in a second file comprising the second recorded content.

12. The method of claim 11, wherein the first file metadata comprises a take number and the second file metadata comprises a different take number than the first file take number.

13. The method of claim 11, wherein creating the second metadata placeholder occurs in response to receiving a selection of a take record mode.

14. The method of claim 11, further comprising incrementing a take number for inclusion in a new metadata placeholder when the new metadata placeholder is created in response to receiving a selection of a take record mode.

15. A method comprising:
receiving a multi-shot plan comprising information about each of a plurality of shots;
creating a metadata placeholder for at least one of the shots of the plurality of shots, the metadata placeholder comprising information about the shot from the multi-shot plan, the metadata placeholder created prior to recording the shot and the information about the shot inputted and included in the metadata placeholder prior to recording the shot;
receiving, at a computer, a selection of a selected metadata placeholder for a shot of the multi-shot plan;
receiving, at the computer, recorded content from a camera recording device as the recorded content is recorded on location for the shot of the multi-shot plan corresponding to the selected metadata placeholder; and
associating, via the computer, the information about the shot from the multi-shot plan from the metadata placeholder with the recorded content.

16. The method of claim 15, wherein associating the information about the shot from the multi-shot plan from the metadata placeholder with the recorded content further comprises embedding the information as metadata in a file comprising the recorded content.

17. The method of claim 15, wherein a source of the multi-shot plan is a written script.

18. The method of claim 15, further comprising, for each of the shots of the multi-shot plan:
controlling the recording device to record recorded content for the shot; and
embedding metadata from a metadata placeholder associated with the shot, wherein embedding the metadata comprises embedding the metadata in a file with the recorded content for the shot.

19. The method of claim 17, further comprising:
receiving a selection of multiple metadata placeholders, each metadata placeholder associated with a file comprising recorded content;
receiving an edit to a metadata field for one of the selected metadata placeholders; and
applying the edit to associated metadata fields for all of the selected placeholders.

20. A system comprising:
a recording device; and
a control device comprising a computer comprising an application capable of:
receiving shot plan metadata for inclusion in metadata placeholders, the metadata placeholder created prior to recording the shot, the shot metadata comprising information inputted and included in the metadata placeholder prior to recording the shot;
controlling a camera of the recording device to record actual footage on location as recorded contents;
receiving recorded contents from the recording device; and
embedding metadata from the metadata placeholders in files comprising the recorded contents.

21. A non-transitory computer-readable medium on which is encoded program code, the program code comprising:
program code for receiving shot metadata for inclusion in a metadata placeholder for a planned shot, the metadata placeholder created prior to recording the shot, the shot metadata comprising information inputted and included in the metadata placeholder prior to recording the shot;
program code for receiving a record command, the record command comprising an identification of the metadata placeholder for the planned shot;
program code for controlling a camera of a recording device to record actual footage on location as recorded content for the planned shot;
program code for receiving the recorded content from the recording device; and
program code for associating the shot metadata from the metadata placeholder with the recorded content.
